(19) United States
(12) Patent Application Publication
(10) Pub. No.: US 2006/0020880 A1
(43) Pub. Date: Jan. 26, 2006

(54) System and method for synchronization of music and images

(76) Inventor: Yi-Kai Chen, Tainan (TW)

Correspondence Address: BIRCH STEWART KOLASCH & BIRCH, PO BOX 747, FALLS CHURCH, VA, 22040-0747, US

(21) Appl. No.: 10/896,237

(22) Filed: Jul. 22, 2004

(51) Int. Cl. G06F 17/21

(52) U.S. Cl. 715/500.1

(57) ABSTRACT

A method for synchronization of a series of still images and music. The method displays one of the still images, plays an audio stream, and partially analyzes music content during a sampling interval of the audio stream using a musical content analysis method. The method further determines an image transition point during the sampling interval, and displays the next still image when the audio stream is played at the image transition point.

### BACKGROUND

The present invention relates to acoustics processing technology, and in particular to a system and method for synchronization of music and images.

Conventional image display systems are capable of not only displaying a series of still images but also simultaneously playing digital audio. Still images may be in various formats, such as GIF, JPEG, SVG, PNG, JPEG 2000, or others. Digital audio may be in various formats, such as MP3, MP4, AAC, VBF, OGG, WAV, or others. The systems often display still images and play digital audio independently.

In order to synchronization of music and images, in U.S. Pat. No. 5,508,470, “Automatic Playing Apparatus Which Controls Display of Images in Association with Contents of A Musical Piece and Method Thereof,” by Tajima et al., describes a Karoke device which plays both music and images. The change of imagery is synchronized to the beat of the music. The music beats, however, are pre-selected and are merely stored as performance data. U.S. Pat. No. 6,639,649, “Synchronization Of Music and Images in a Camera with Audio Capabilities,” by Fredlund et al., additionally describes a system which analyses an entire audio recording and determines when to display a series of stored still images.

Although the synchronization methods are capable of determining transitions for still images, several limitations remain. Excessive time and computing resource are expended by analyzing the entire audio data, thus, slowing response time. In view of the described limitations, a need exists for a system and method providing quick analysis and response.

### SUMMARY

An embodiment of the invention discloses a method for synchronization of a series of still images and music. The method displays one of the still images, plays an audio stream, and partially analyzes music content during a sampling interval of the audio stream using a musical content analysis method. The method further determines an image transition point during the sampling interval, and displays the next still image when the audio stream is played at the image transition point. Preferably, the method determines a partition point in the audio stream that has not been played, determines the sampling interval based on the partition point, and determines a transition point inside the sampling interval. The audio stream is divided into portions of equal or non-equal size indicated by the partition point.

An embodiment of the invention discloses a system for synchronization of images and music. The system comprises a storage device, a display device, an audio device and a processing unit. The storage device stores an audio stream and a series of still images. The audio device is configured to play the audio stream. The processing unit directs the display device to display one of the still images, analyzes music content during a sampling interval of the audio stream using a musical content analysis method, determines an image transition point during the sampling interval, and displays the next still image when the audio stream is played at the image transition point. Preferably, the processing unit determines a partition point in the audio stream that has not been played, determines the sampling interval based on the partition point, and determines a transition point inside the sampling interval.

An embodiment of the invention additionally discloses a computer-readable storage medium for storing a computer program which when executed performs the method for synchronization of images and music.

Preferably, the audio stream is formatted in MP3, MP4, AAC, VBF, OGG or WAV. Each still image is formatted in GIF, JPEG, SVG, PNG or JPEG 2000. The musical content analysis method is employed to acquire an attack time for an instrument, a melody discontinuity, a beat onset, a pitch discontinuity, a maximum rough peak value or a minimum rough valley value.

### BRIEF DESCRIPTION OF THE DRAWINGS

Embodiments of the present invention can be more fully understood by reading the subsequent detailed description and examples with references made to the accompanying drawings, wherein:

FIG. 1 is a diagram of the system architecture for synchronization of music and images according to an embodiment of the invention;

FIG. 2 is a flowchart illustrating the method for real-time synchronization of music and images according to a first embodiment of the invention;

FIG. 3 is a schematic diagram of synchronization of music and still images according to a first embodiment of the invention;

FIG. 4 is a flowchart illustrating the method for synchronization of music and images using batch processing according to a second embodiment of the invention;

FIG. 5 is a schematic diagram of synchronization of music and still images according to a second embodiment of the invention;

FIG. 6 is a system block diagram for synchronization of images and music according to an embodiment of the invention;

FIG. 7 is a diagram of a storage medium for a computer program providing the method for synchronization of images and music according to an embodiment of the invention.

### DETAILED DESCRIPTION

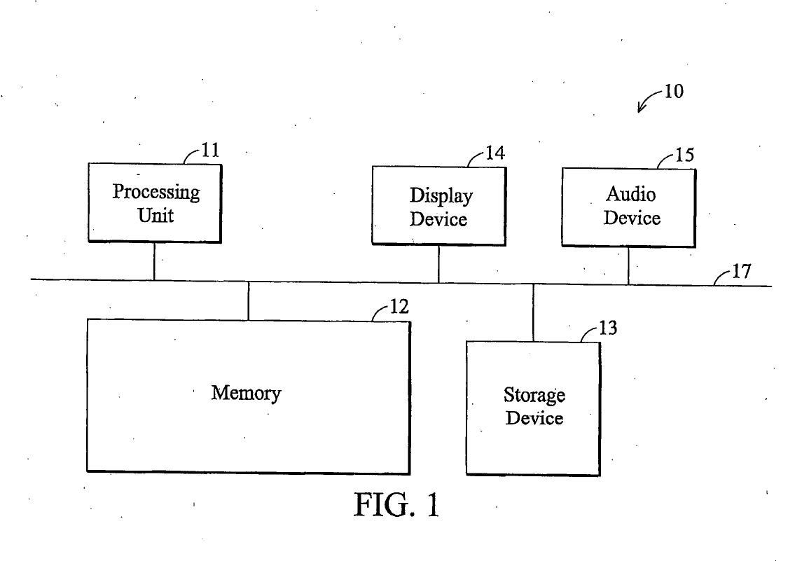

FIG. 1 is a diagram of the system architecture for synchronization of music and images according to an embodiment of the invention. The system 10 includes a processing unit 11, a memory 12, a storage device 13, a display device 14 and an audio device 15. The processing unit 11 is connected by buses 17 to the memory 12, storage device 13, display device 14 and audio device 15 based on Von Neumann architecture. It will be apparent to those skilled in the art that the embodiment may be practiced with other computer system configurations, including hand-held devices, multiprocessor-based, microprocessor-based or programmable consumer electronics, network PC's, minicomputers, mainframe computers, and the like. There may be only one or there may be more than one processing unit 11, such that the processor of computer 10 comprises a single central processing unit (CPU), or multiple processing units, commonly referred to as a parallel processing environment. The memory 12 is preferably a random access memory (RAM), but may also include read-only memory (ROM) or flash ROM. The memory 12 preferably includes program modules which include routines, programs, objects, components, or others, for performing functions of synchronization of music and images. Embodiments may also be practiced in distributed computing environments where tasks are performed by remote processing devices linked through a communication network. In a distributed computing environment, program modules may be located in both local and remote memory storage devices. The storage device 13 may be a hard disk drive reading from and writing to a hard disk, a magnetic disk drive reading from and writing to a magnetic disk or an optical disk drive reading from or writing to a removable optical disk. The drives and their associated computer-readable media provide nonvolatile storage of program modules, music files (i.e., audio streams), configuration files, configuration records, still images and other data for the computer 10.

### First Embodiment

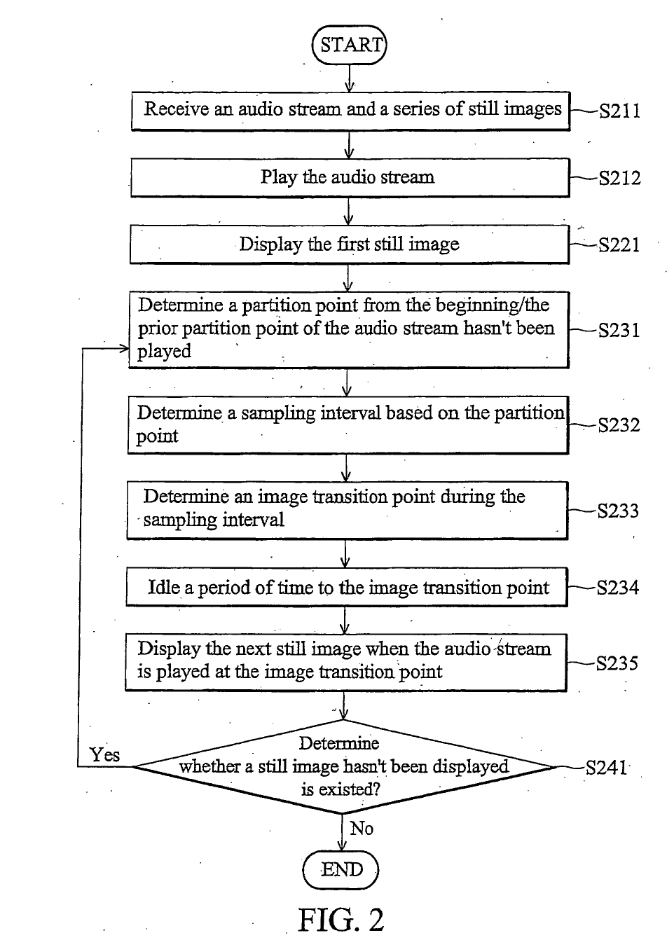

A first embodiment discloses a method for real-time synchronization of music and images, the method is implemented in program modules and executed by the processing unit 11. FIG. 2 is a flowchart illustrating the method for real-time synchronization of music and images according to a first embodiment of the invention.

The method begins in step S211 by receiving an audio stream and a series of still images. The still images may be in one or more image formats, such as GIF, JPEG, SVG, PNG, JPEG 2000, and the like. The audio stream may be in an audio format, such as MP3, MP4, AAC, VBF, OGG, WAV, and the like. In step S212, the audio stream is played via the audio device 15. In step S221, the first still image is displayed via the display device 14.

The loop (steps S231 to S241) is responsible for repeatedly determining an image transition point and displaying the next still image when the audio stream is played at the transition point until all still images are displayed. In step S231, a partition point is determined from the beginning or a prior partition point of the audio stream. Its length from the beginning/prior partition point may be a fixed or variable length. In an example, the length is calculated using Equation (1).
L_{seg}=Lₜₒₜₐₗ/(N_{img}−1), Equation (1):
where Lₜₒₜₐₗ represents the total length of the audio stream and N_{img} represents the number of still images. In addition, its length from the beginning/prior partition point may be stored in a configuration file or record. In step S232, a sampling interval is determined based on the determined partition point, preferably the determined partition point being the center of the sampling interval. Preferably, the length of the sampling interval is approximately about 10% to 30% of Lseg or stored in a configuration file or record. In step S233, an image transition point is determined during the sampling interval using a musical content analysis method. The musical content analysis method being well-known in the art, acquires an attack time for an instrument, a melody discontinuity, a beat onset, a pitch discontinuity, a maximum rough peak value, a minimum rough valley value, or other acoustic features. In step S234, the process idle until the audio stream is played at the transition point. In step S235, the next still image is displayed, and preferably employs a transition effect, such as zoom-in, fade-in, fly-in and the like, before appearance of the next still image. In step S241, the process determines whether a still image that has not been displayed exists. If so, the process proceeds to step S231; and otherwise, the process ends.

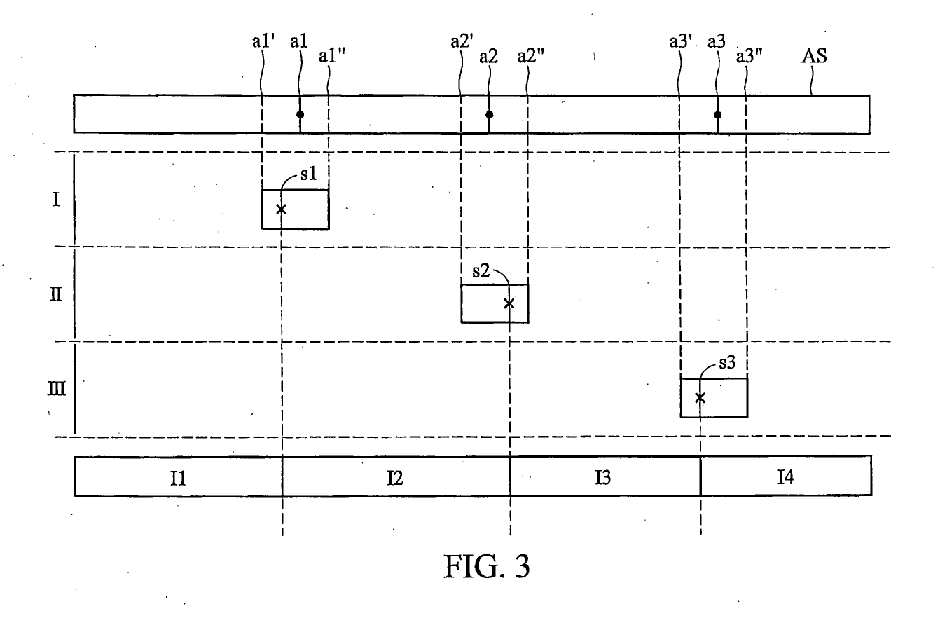

FIG. 3 is a schematic diagram of synchronization of music and still images according to a first embodiment of the invention. Initially, an audio stream AS and a series of still images, I1 to I4, are received. Referring to step S212, the audio stream AS is played via the audio device 15. Referring to step S221, the first still image I1 is displayed.

Thereafter, referring to steps S231 to S235, the first embodiment of the invention determines a partition point a1, a sampling interval, a1′ to a1″, based on the partition point, a transition point s1 during the sampling interval using a musical content analysis method, and displays the next still image I2 when the audio stream is played at the transition point S1. Referring to S241, the process proceeds to step S231 because the still images, I3 and I4, are not displayed.

Subsequently, referring to steps S231 to S235, the first embodiment of the method determines a partition point a2, a sampling interval, a2′ to a2″, a transition point s2, and displays the next still image I3 when the audio stream is played at the transition point S2. Referring to S241, the process proceeds to step S231 because the still image I4 is not displayed.

Referring to steps S231 to S235, the first embodiment of the method determines a partition point a3, a sampling interval, a3′ to a3″, a transition point s3, and displays the next still image I4 when the audio stream is played at the transition point S3. Referring to step S241, the process ends because all still images are displayed.

### Second Embodiment

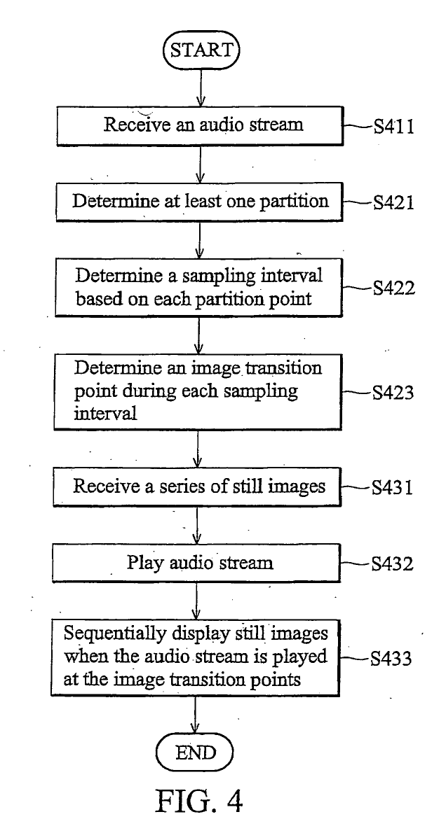

A second embodiment discloses a method for synchronization of music and images using batch processing, the method is implemented in program modules and executed by the processing unit 11. FIG. 4 is a flowchart illustrating the method for synchronization of music and images using batch processing according to a second embodiment of the invention.

The method begins in step S411 by receiving an audio stream. The audio stream may be in an audio format, such as MP3, MP4, AAC, VBF, OGG, WAV, and the like. In step S421, at least one partition point is determined. Its length from the beginning/prior one may be a fixed or variable length. Preferably, the length is calculated using Equation (1). In addition, the length from the beginning/prior partition point may be stored in a configuration file or record. In step S422, a sampling interval is determined based on the determined partition point, preferably the determined partition point being the center of the sampling interval. Preferably, the length of the sampling interval is approximately about 10% to 30% of L_{seg} or stored in a configuration file or record. In step S423, an image transition point is determined during the sampling interval using a musical content analysis method. The musical content analysis method being well-known in the art, acquires an attack time for an instrument, a melody discontinuity, a beat onset, a pitch discontinuity, a maximum rough peak value, a minimum rough valley value, or other acoustic features. In step S431, a series of still images are acquired. The still images may be in one or more image formats, such as GIF, JPEG, SVG, PNG, JPEG 2000, and the like. In step S432, the audio stream is played via the audio device 15. In step S433, the still images are sequentially displayed via the display device 14 at the image transition points. Preferably, the method employs a transition effect, such as zoom-in, fade-in, fly-in and the like, before appearance of the next still image.

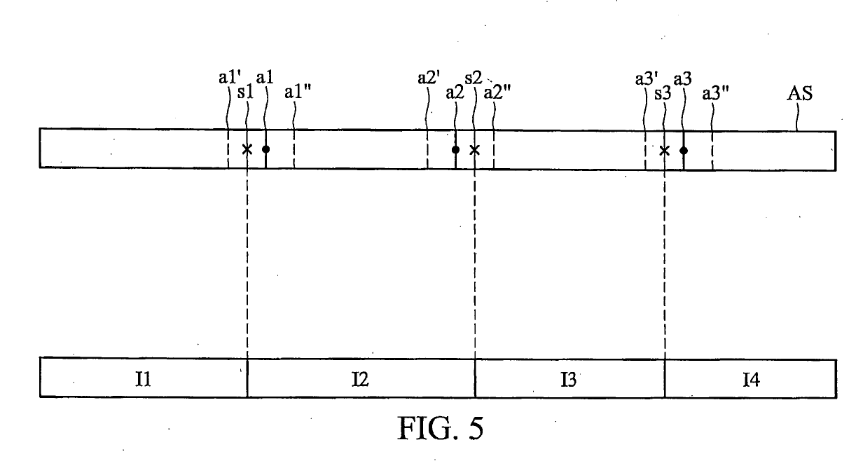

FIG. 5 is a schematic diagram of synchronization of music and still images according to a second embodiment of the invention. Referring to step S411, an audio stream AS is received. Referring to step S421, three partition points, al to a3, are acquired by equally (if possible) dividing the audio stream AS into four portions. Referring to step S422, three sampling intervals such as a1′ to a1″, a2′ to a2″ and a3′ to a3″ are determined based on the determined partition points. Referring to S423, three image transition points such as s1, s2 and s3, are determined during the sampling intervals using a musical content analysis method. Referring to step S432, the audio stream AS is played via the audio device 15. Referring to step S433, still images I2, I3 and I4 are sequentially displayed via the display device 14 when the audio stream AS is played at the image transition points S1, S2 and S3.

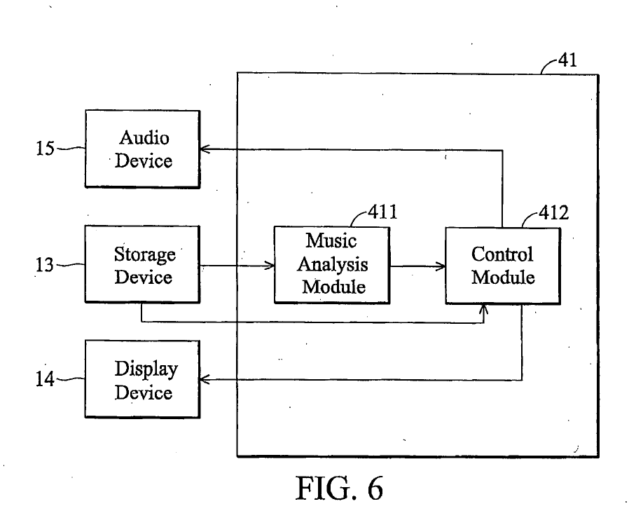

Embodiments of the invention further disclose a system for synchronization of images and music. FIG. 6 is a system block diagram for synchronization of images and music according to an embodiment of the invention. The system 41 preferably comprises a music analysis module 411 and a control module 412. The music analysis module 412 acquires an audio stream from the storage device 13, determines at least one partition point and determines a sampling interval based on each of the partition point. The music analysis module 412 additionally determines an image transition point during each of the sampling intervals using a musical content analysis method, and transmits the image transition points to the control module 412. The control module 412 acquires the audio stream and a series of still images from the storage device 13, and respectively directs the audio device 15 to play the audio stream and display device 14 to display the first still image. The control module 412 further directs the display device 14 to display the next still image when the audio stream is played at the next transition point.

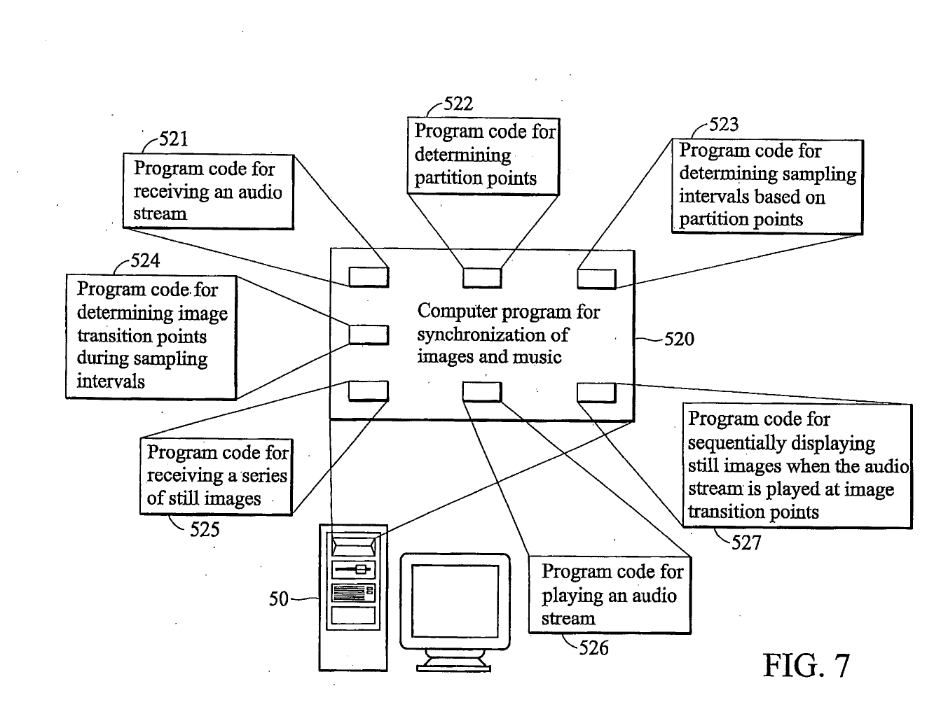

Embodiments of the invention additionally disclose a storage medium for storing a computer program providing the disclosed method for synchronization of images and music, as shown in FIG. 7. The computer program product includes a storage medium 50 having computer readable program code embodied in the medium for use in a computer system, the computer readable program code comprising at least computer readable program code 521 receiving an audio stream, computer readable program code 522 determining partition points, computer readable program code 523 determining sampling intervals based on partition points, computer readable program code 524 determining image transition points during sampling intervals, computer readable program code 525 receiving a series of still images, computer readable program code 526 playing an audio stream and computer readable program code 527 sequentially displaying still images when the audio stream is played at image transition points.

The methods and system of embodiments of the invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method for synchronization of a series of still images and music, the method comprising using a computer performing the steps of:
displaying one of the still images;
playing an audio stream;
analyzing music content during a sampling interval of the audio stream using a musical content analysis method;
determining an image transition point during the sampling interval; and
displaying the next still image when the audio stream is played at the image transition point.

2. The method as claimed in claim 1 wherein the audio stream is formatted in MP3, MP4, AAC, VBF, OGG or WAV.

3. The method as claimed in claim 1 wherein each of the still images is formatted in GIF, JPEG, SVG, PNG or JPEG 2000.

4. The method as claimed in claim 1 wherein the musical content analysis method is employed to acquire an attack time for an instrument, a melody discontinuity, a beat onset, a pitch discontinuity, a maximum rough peak value or a minimum rough valley value.

5. The method as claimed in claim 1 further comprising the steps of:
determining a partition point in the audio stream that has not been played; and
determining the sampling interval based on the partition point.

6. The method as claimed in claim 1 wherein the audio stream is divided into portions of equal size indicated by the partition point.

7. The method as claimed in claim 6 wherein the musical content analysis method is employed to acquire an attack time for an instrument, a melody discontinuity, a beat onset, a pitch discontinuity, a maximum rough peak value or a minimum rough valley value.

8. A system for synchronization of images and music, comprising:
a storage device capable of storing an audio stream and a series of still images;
a display device;
an audio device configured to play the audio stream; and
a processing unit configured to direct the display device to display one of the still images, analyze music content during a sampling interval of the audio stream using a musical content analysis method, determine an image transition point during the sampling interval, and display the next still image when the audio stream is played at the image transition point.

9. The system as claimed in claim 8 wherein the audio stream is formatted in MP3, MP4, AAC, VBF, OGG or WAV.

10. The system as claimed in claim 8 wherein each of the still image is formatted in GIF, JPEG, SVG, PNG or JPEG 2000.

11. The system as claimed in claim 8 wherein the musical content analysis method is employed to acquire an attack time for an instrument, a melody discontinuity, a beat onset, a pitch discontinuity, a maximum rough peak value or a minimum rough valley value.

12. The system as claimed in claim 8 wherein the processing unit determines a partition point in the audio stream that has not been played, and determines the sampling interval based on the partition point.

13. The system as claimed in claim 12 wherein the audio stream is divided into portions of equal size indicated by the partition point.

14. The system as claimed in claim 13 wherein the musical content analysis method is employed to acquire an attack time for an instrument, a melody discontinuity, a beat onset, a pitch discontinuity, a maximum rough peak value or a minimum rough valley value.

15. A computer-readable storage medium for storing a computer program which when executed performs a method for synchronization of a series of still images and music, the method comprising the steps of:
displaying one of the still images;
playing an audio stream;
analyzing music content during a sampling interval of the audio stream using a musical content analysis method;
determining an image transition point during the sampling interval; and
displaying the next still image when the audio stream is played at the image transition point.
